(19) United States
(12) Patent Application Publication
(10) Pub. No.: US 2019/0102279 A1
(43) Pub. Date: Apr. 4, 2019

(54) GENERATING AN INSTRUMENTED SOFTWARE PACKAGE AND EXECUTING AN INSTANCE THEREOF

(71) Applicant: Layered Insight, Inc., Pleasanton, CA (US)

(72) Inventors: Asif Awan, Dublin, CA (US); John Laurence Kinsella, San Francisco, CA (US); Sachin Aggarwal, San Ramon, CA (US)

(73) Assignee: Layered Insight, Inc., Pleasanton, CA (US)

(21) Appl. No.: 16/033,215

(22) Filed: Jul. 12, 2018

Related U.S. Application Data
(60) Provisional application No. 62/567,757, filed on Oct. 4, 2017.

(51) Int. Cl. G06F 11/36; G06F 9/445

(52) U.S. Cl. CPC G06F 11/3644; G06F 11/3612; G06F 9/44521

(57) ABSTRACT

Techniques for generating an instrumented software package and executing an instance thereof are disclosed. A software package, such as a container image, includes a library of system call wrapper functions. An instrumented system call wrapper function includes (a) a corresponding system call wrapper function and (b) instrumentation code. Instrumentation code is configured to perform one or more of: (a) capturing data associated with executing the set of operations associated with requesting the system call, and (b) manipulating execution of the set of operations associated with requesting the system call. An instrumented library, including instrumented system call wrapper functions, is added to the software package to generate an instrumented software package. An instrumentation configuration is applied to an instance of the instrumented software package. The instrumentation configuration indicates which portions of instrumentation code to set to an “on state,” and which portions of instrumentation code to set to an “off state.”

### BENEFIT CLAIM; INCORPORATION BY REFERENCE

This application claims the benefit of U.S. Provisional Patent Application 62/567,757, filed Oct. 4, 2017, which is hereby incorporated by reference.

The Applicant hereby rescinds any disclaimer of claim scope in the parent application(s) or the prosecution history thereof and advises the USPTO that the claims in this application may be broader than any claim in the parent application(s).

### TECHNICAL FIELD

The present disclosure relates to software instrumentation. In particular, the present disclosure relates to generating an instrumented software package and executing an instance thereof.

### BACKGROUND

Hardware and software needed for executing an application include, for example: a host machine (physical or virtual), an operating system (OS) and a kernel thereof, one or more libraries (such as standard libraries of particular programming languages), and the code for the application itself.

A software package includes code for one or more applications, and optionally associated libraries and/or other information, that is executable on a host machine. Multiple copies of the same software package may be instantiated and/or executed on one or more host machines. An instantiated software package may be referred to as a “software package instance.” Examples of software packages include a container image and a virtual machine (VM) image. Examples of software package instances include a container instance and a VM instance.

Developers, software providers, and/or other users desire to monitor and/or analyze the behavior of various software package instances. Users may monitor and/or analyze the behavior of a software package instance to determine performance issues, security issues, and/or other issues.

Monitoring the behavior of a software package instance may be performed by monitoring the network traffic entering and/or exiting the software package instance. However, such monitoring obtains information limited to data that is entering and/or exiting the software package instance. Data being processed within the software package instance cannot be captured. Moreover, such monitoring may require special host-level and/or environment-level privileges.

Monitoring the behavior of a software package instance may be performed by capturing data being processed by a kernel that executes the software package instance. However, such monitoring obtains information limited to data that is processed by the kernel. Data being processed by application code and/or libraries of the software package instance cannot be directly captured. Moreover, such monitoring requires special kernel privileges. A host agent with special kernel privileges needs to be installed on the OS.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1A illustrates an example process flow for a software package, in accordance with one or more embodiments;

FIG. 1B illustrates an example software package instrumentation system, in accordance with one or more embodiments;

FIG. 1C illustrates example instrumented software package instances, in accordance with one or more embodiments;

FIGS. 2A-B illustrate an example set of operations for generating an instrumented software package, in accordance with one or more embodiments;

FIG. 3 illustrates an example set of operations for randomizing an instrumentation configuration for instrumented software package instances, in accordance with one or more embodiments; and

FIG. 4 shows a block diagram that illustrates a computer system in accordance with one or more embodiments.

### DETAILED DESCRIPTION

In the following description, for the purposes of explanation, numerous specific details are set forth in order to provide a thorough understanding. One or more embodiments may be practiced without these specific details. Features described in one embodiment may be combined with features described in a different embodiment. In some examples, well-known structures and devices are described with reference to a block diagram form in order to avoid unnecessarily obscuring the present invention.
1. GENERAL OVERVIEW
2. PROCESS FLOW FOR A SOFTWARE PACKAGE
3. SOFTWARE PACKAGE INSTRUMENTATION SYSTEM ARCHITECTURE
4. GENERATING AN INSTRUMENTED SOFTWARE PACKAGE
5. RANDOMIZING AN INSTRUMENTATION CONFIGURATION FOR INSTRUMENTED SOFTWARE PACKAGE INSTANCES
6. HARDWARE OVERVIEW
7. MISCELLANEOUS; EXTENSIONS

1. General Overview

One or more embodiments include generating an instrumented software package. A software package includes one or more wrapper functions for system calls to a kernel of an operating system (OS). A wrapper function includes a set of operations associated with requesting a particular system call. For each wrapper function, a corresponding instrumented wrapper function is obtained. An instrumented wrapper function includes: (a) the wrapper function itself and (b) instrumentation code. Instrumentation code is configured to perform one or more of: (a) capturing data associated with executing the set of operations associated with requesting the system call, and (b) manipulating execution of the set of operations associated with requesting the system call. The instrumented wrapper function is added to the software package in order to generate an instrumented software package. When an instance of the instrumented software package is executed, a call to a particular wrapper function results in execution of the corresponding instrumented wrapper function rather than the particular wrapper function.

One or more embodiments include determining an instrumentation configuration for an instrumented software package instance. An instrumentation configuration indicates which subsets of instrumentation code, within an instrumented software package, to set to an “on state.” Additionally or alternatively, an instrumentation configuration indicates which subsets of instrumentation code, within an instrumented software package, to set to an “off state.” An instrumentation configuration for an instrumented software package instance may be determined based on a behavior of the instrumented software package instance. Additionally or alternatively, an instrumentation configuration for an instrumented software package instance may be determined based on various factors, such as a random function, a geographical location associated with the instrumented software package instance, and/or the types of external data (from the user and/or other applications) that the instrumented software package is handling. An instrumented software package instance is configured based on the determined instrumentation configuration.

By inserting instrumentation code into the wrapper function, data being processed by application code and/or libraries of the instrumented software package instance is directly captured. Moreover, the instrumentation code may be executed without any special kernel privileges.

Since instrumentation code is inserted in an instrumented software package instance, the state (on or off) of the instrumentation code is configurable. Different instrumentation configurations may be applied to different instances of the same instrumented software package. Instrumentation configurations of the different instrumented software package instances may be randomized, such that the instrumentation code in one instrumented software package instance is turned on, and the same instrumentation code in another instrumented software package instance is turned off. By randomizing the configurations, a potential attacker on a set of instrumented software package instances will face greater difficulty predicting the behavior of each instrumented software package instances, and thereby face greater difficulty successfully launching an attack.

One or more embodiments described in this Specification and/or recited in the claims may not be included in this General Overview section.

2. Process Flow for a Software Package

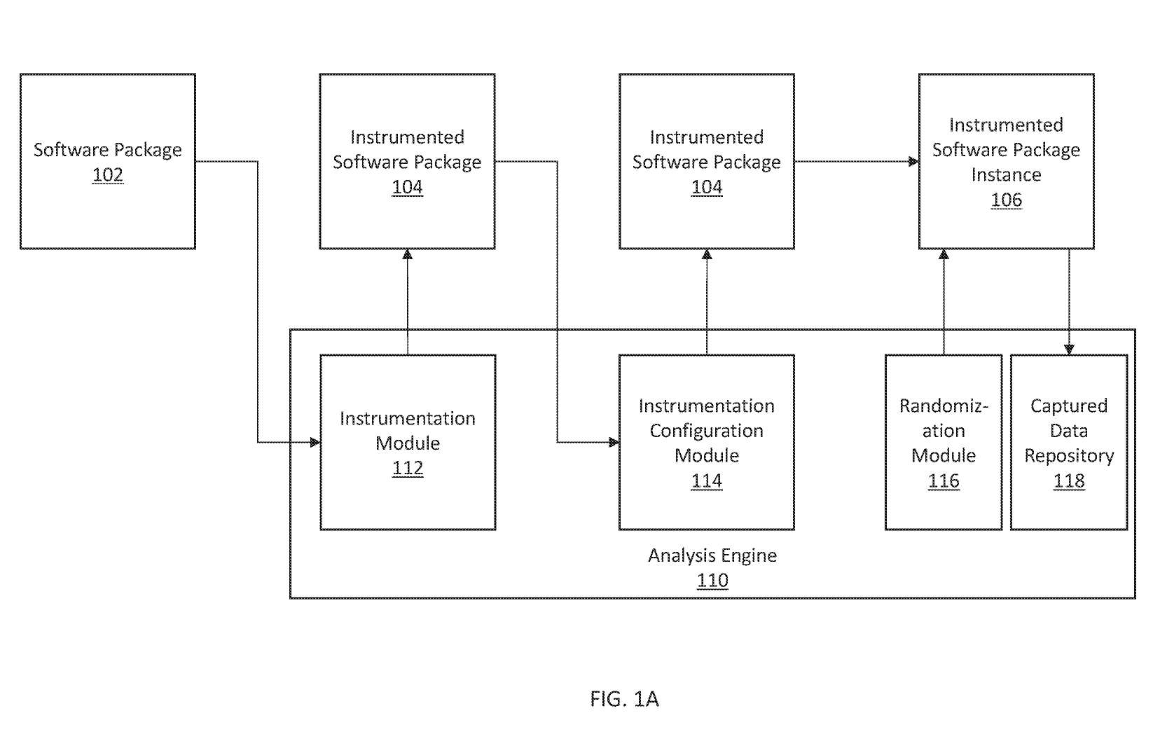

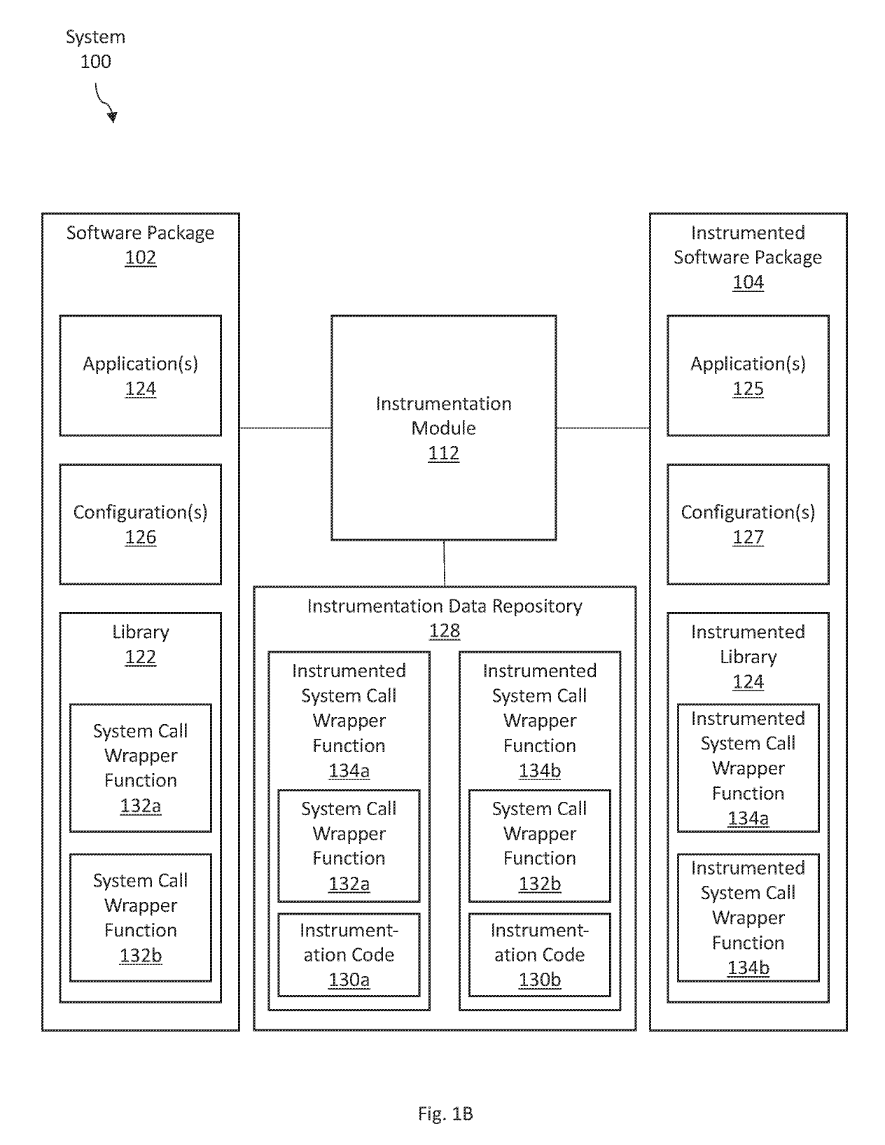

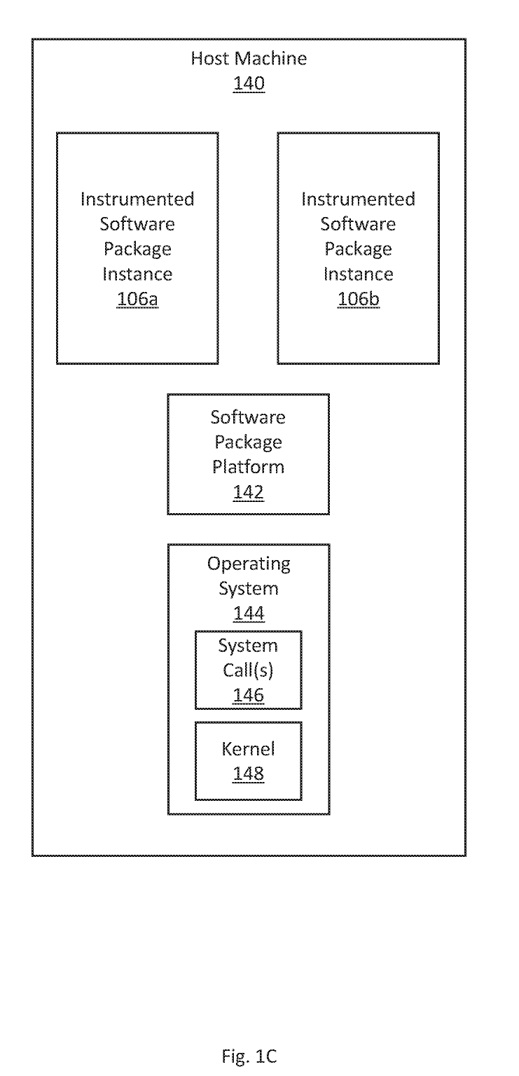

FIG. 1A illustrates an example process flow for a software package, in accordance with one or more embodiments. As illustrated, a process flow for a software package 102 includes the software package 102, an instrumented software package 104, and an instrumented software package instance. An analysis engine 110 that performs operations on the software package 102 includes: an instrumentation module 112, an instrumentation configuration module 114, a randomization module 116, and/or a captured data repository 118. In one or more embodiments, an analysis engine 110 may include more or fewer components than the components illustrated in FIG. 1A. The components illustrated in FIG. 1A may be local to or remote from each other. The components illustrated in FIG. 1A may be implemented in software and/or hardware. Each component may be distributed over multiple applications and/or machines. Multiple components may be combined into one application and/or machine. Operations described with respect to one component may instead be performed by another component. Components labeled with the same numerals refer to the same components across FIGS. 1A-C.

In one or more embodiments, a developer, software provider, and/or other user develops a software package 102. The user stores the software package 102 at a storage location (such as, a local disk associated with the user's computer, a cloud server, and/or a registry of software packages ready for deployment). The software package 102 includes code for one or more applications, and optionally associated libraries and/or other information, that is executable on a host machine.

In one or more embodiments, an instrumentation module 112 obtains the software package 102 pushed by the user. The instrumentation module 112 inserts instrumentation code into the software package 102. The instrumentation module 112 may insert the instrumentation code after the software package 102 is built but before the software package 102 is deployed. Additionally or alternatively, the instrumentation module 112 may insert the instrumentation code as the software package 102 is being built, for example, during the process of linking the application code with the associated dependencies (such as, dependencies on system calls).

The output of the instrumentation module 112 is an instrumented software package 104. Instrumentation code may be included in one or more of: (a) application code within the instrumented software package 104, and (b) a library within the instrumented software package 104. Instrumentation code is configured to perform one or more of: (a) capturing data associated with executing the set of operations associated with requesting the system call, and (b) manipulating execution of the set of operations associated with requesting the system call.

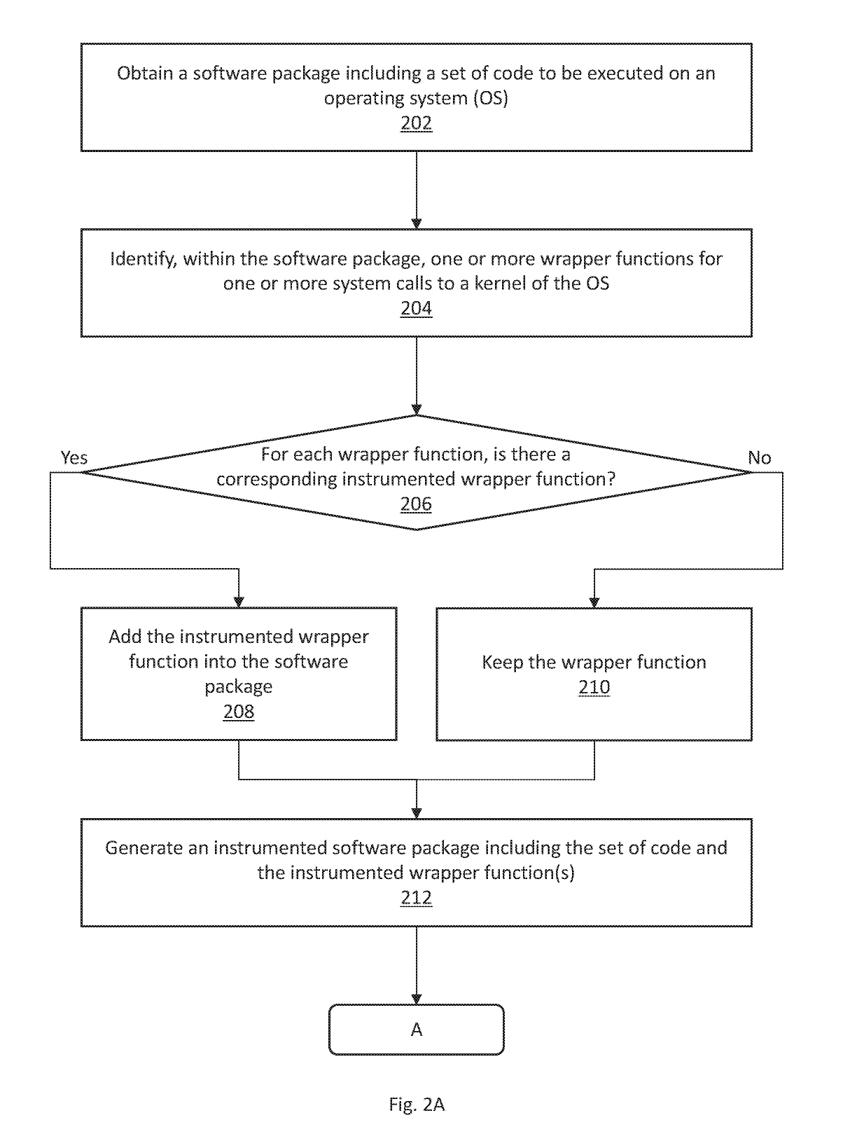

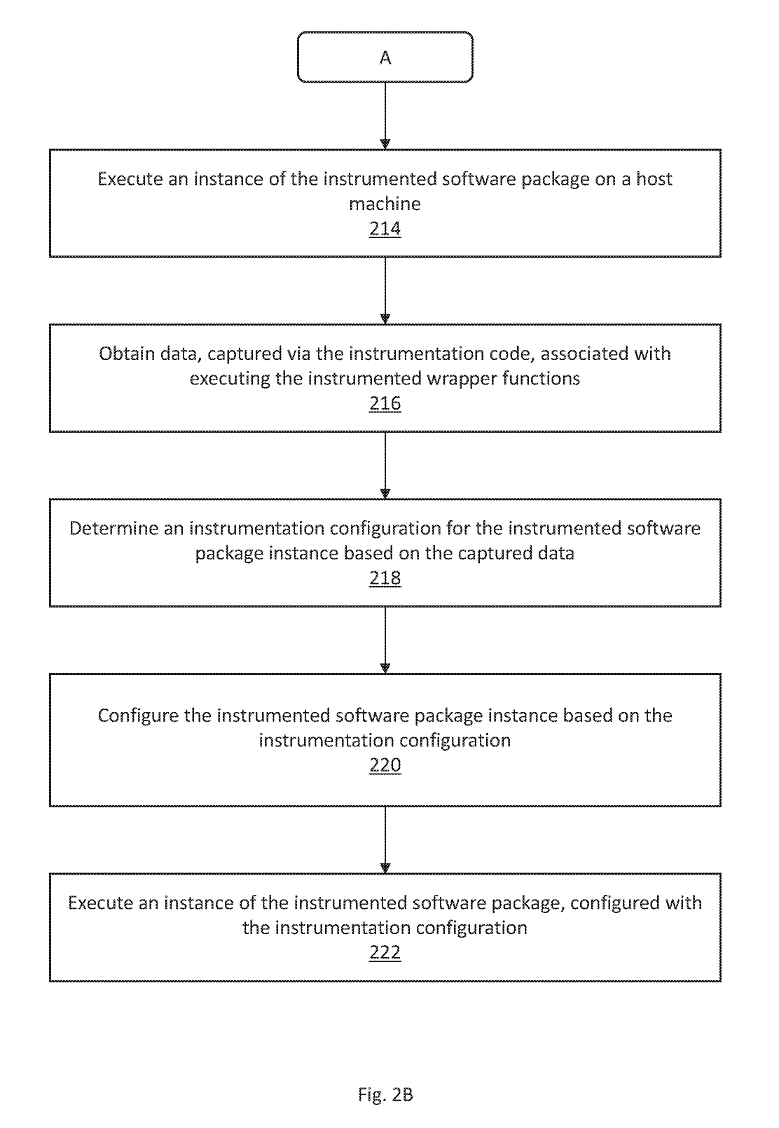

Further examples of operations for generating an instrumented software package 104 are further described below with reference to FIGS. 2A-B.

In one or more embodiments, an instrumentation configuration module 114 determines an instrumentation configuration for an instrumented software package 104. An instance of the instrumented software package 104 may be executed in “observation mode.” Data is captured by the instrumentation code, within the instrumented software package 104, during execution in “observation mode.” The captured data is used to determine a behavior of the instrumented software package instance. Based on the behavior of the instrumented software package instance, an instrumentation configuration is determined for the instrumented software package instance. The instrumented software package instance is configured according to the determined instrumentation configuration.

An instrumentation configuration sets states for various portions of the instrumentation code within an instrumented software package. An instrumentation configuration indicates which portions of instrumentation code are set to an “on state,” and which portions of instrumentation code are set to an “off state.” Portions of instrumentation code that is set to an on state operate as specified by the instrumentation code. Portions of instrumentation code that is set to an off state are turned off and do not perform any operations.

Further examples of operations for determining an instrumentation configuration for an instrumented software package instance 106 are further described below with reference to FIGS. 2A-B.

In one or more embodiments, an instance 106 of an instrumented software package 104 is instantiated and/or executed, on a host machine, with the instrumentation configuration determined by the instrumentation configuration module 114. Multiple copies of the same instrumented software package 104 may be instantiated and/or executed on one or more host machines. Additionally or alternatively, different instrumented software packages 104 may be instantiated and/or executed on one or more host machines.

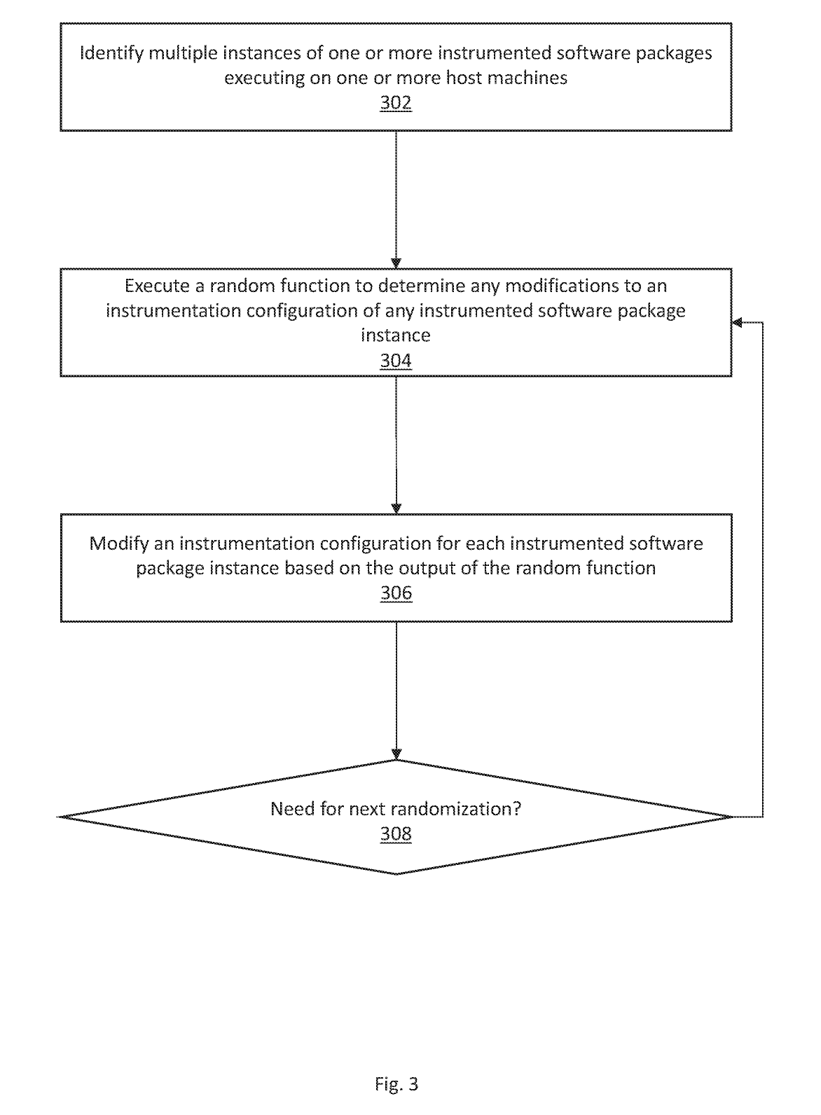

Further examples of operations for instantiating and/or executing an instrumented software package instance 106 are further described below with reference to FIGS. 2A-B and FIG. 3.

In one or more embodiments, during execution, data is captured by the instrumentation code within the instrumented software package 104. The data is stored in a captured data repository 118 for further analysis. As an example, an analysis application may be configured to analyze the captured data stored in the captured data repository. As another example, a user interface may present, to a user, the captured data stored in the captured data repository. As another example, the captured data stored in a captured data repository may be fed back into an instrumentation configuration module to further refine and/or modify an instrumentation configuration for the instrumented software package instance. The further modification of the instrumentation configuration may be performed with or without human intervention.

Further examples of operations for obtaining data captured from an instrumented software package instance 106 are further described below with reference to FIGS. 2A-B and FIG. 3.

In one or more embodiments, a randomization module 116 modifies an instrumentation configuration for one or more instrumented software package instances 106. The randomization module 116 executes a random function to determine states (such as an on state, or an off state) for various portions of instrumentation code within an instrumented software package 104. The instrumented software package instance 106 is configured according to the output of the random function. Hence, different instrumented software package instances 106 may be configured differently, even if the instrumented software package instances 106 are instantiated from the same instrumented software package 104.

Further examples of operations for randomizing instrumentation configurations for one or more instrumented software package instances 106 are further described below with reference to FIG. 3.

The above described process flow for a software package 102 may be used within a continuous integration, continuous delivery, continuous testing, and/or continuous deployment software development process. As an example, a developer may push a software package 102 onto a pipeline within a software development process. The pipeline may include an analysis engine 110, which includes an instrumentation module 112, an instrumentation configuration 114, a randomization module 116, and/or a captured data repository 118. As part of the pipeline, the analysis engine 110 generates an instrumented software package 104 and determines an instrumentation configuration therefor. The instrumented software package 104, along with the determined instrumentation configuration, are pushed for production and/or deployment.

3. Software Package Instrumentation System Architecture

FIG. 1B illustrates an example software package instrumentation system, in accordance with one or more embodiments. As illustrated in FIG. 1B, a system 100 includes a software package 102, an instrumentation module 112, an instrumentation data repository 128, and an instrumented software package 104. In one or more embodiments, a system 100 may include more or fewer components than the components illustrated in FIG. 1B. The components illustrated in FIG. 1B may be local to or remote from each other. The components illustrated in FIG. 1B may be implemented in software and/or hardware. Each component may be distributed over multiple applications and/or machines. Multiple components may be combined into one application and/or machine. Operations described with respect to one component may instead be performed by another component. Components labeled with the same numerals refer to the same components across FIGS. 1A-C.

As described above with reference to FIG. 1A, a software package 102 includes code for one or more applications 124, and optionally associated libraries 122 and/or other information, that is executable on a host machine. Examples of software packages 102 include a container image and a virtual machine (VM) image. Examples of software package instances include a container instance and a VM instance.

A container image does not include its own kernel. A container instance cannot use any kernel within the container image itself, but rather relies on the kernel of the host machine upon which the container instance is executing. Multiple container instances, executing on the same host machine, may share the same kernel of the host machine. Meanwhile, a container image may include its own set of libraries. Container instances do not share libraries with each other. One container instance does not use and/or access the libraries of another container instance.

A VM image includes its own kernel and its own set of libraries. There are various ways to execute a VM instance. As an example, a kernel of a VM instance may execute on top of a kernel of the host machine upon which the VM instance is executing. As another example, a kernel of a VM image may execute on a direct abstraction of the host's hardware. Regardless of the method used for executing VM instances, VM instances do not share kernels with each other. One VM instance does not use and/or access the kernel of another VM instance.

In one or more embodiments, an application 124 includes one or more programs, services, and/or functions, which are written as a set of code that is executable on a machine.

In one or more embodiments, a library 122 includes one or more functions, methods, and/or operations, which are written as a set of code that is executable on a machine. Multiple applications 124 within a software package 102 may share a library 122. Each of the multiple applications 124 may access resources, such as methods and variable definitions, within the library 122. A library 122 may be static or dynamic. A static library is bound to an application statically at compile time and/or link time. A dynamic library (also referred to as a “shared library”) is loaded at the time an application is loaded, and binding and/or linking occurs during runtime.

A library 122 may be made available across implementations of a programming language. A library 122 may be described in a programming language specification. In Linux, for example, standard libraries include but are not limited to libc (the standard C library), glibc (the GNU version of the standard C library), libcurl (multiprotocol file transfer library), and/or libcrypt (library used for encryption, hashing, and encoding in C).

In an embodiment, a library 122 includes one or more system call wrapper functions 132a-b. A system call wrapper function (such as any of system call wrapper functions 132a-b) serves as an intermediary between an application 124 and a kernel of an OS. In particular, a system call wrapper function is a wrapper function for a system call to a kernel of an OS. Further details regarding system calls are described below with reference to FIG. 1C.

A system call wrapper function includes code that makes a system call to a kernel. A system call wrapper function may expose an application programming interface (API) for using a system call. Additionally or alternatively, a system call wrapper function may increase the modularity and/or portability of a system call. As an example, a system call wrapper function may place arguments to be passed to a system call into the appropriate processor registers (and/or the call stack). As another example, a system call wrapper function may determine a system call number or identifier for the kernel to call. A system call number or identifier is a unique identifier assigned to each system call to a kernel of a particular OS.

In one or more embodiments, a software package 102 is configured with one or more configurations 126. Examples of configurations 126 include limitations on usage of a central processing unit (CPU), limitations on memory usage, and settings for environment variables. Configuration 126 may be stored in a configuration file associated with a software package 102. The configuration file may be stored within the software package 102 itself, or separate from the software package 102. Additionally or alternatively, configurations 126 may be stored in a configuration file associated with a software package platform that executes an instrumented software package instance. Further details regarding software package platforms are described below with reference to FIG. 1C.

In one or more embodiments, an instrumentation module 112 refers to hardware and/or software configured to generate an instrumented software package 104 from a software package 102. Examples of operations for generating an instrumented software package 104 are described below with reference to FIGS. 2A-B.

In an embodiment, an instrumentation module 112 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a mainframe, a television, a content receiver, a set-top box, a printer, a mobile handset, a smartphone, a personal digital assistant (PDA), and/or any Internet of Things (IoT) device.

In one or more embodiments, a data repository 128 is any type of storage unit and/or device (e.g., a file system, database, collection of tables, or any other storage mechanism) for storing data. Further, a data repository 128 may include multiple different storage units and/or devices. The multiple different storage units and/or devices may or may not be of the same type or located at the same physical site. Further, a data repository 128 may be implemented or may execute on the same computing system as an instrumentation module 112. Alternatively or additionally, a data repository 128 may be implemented or executed on a computing system separate from an instrumentation module 112. A data repository 128 may be communicatively coupled to an instrumentation module 112 via a direct connection or via a network.

Information describing instrumented system call wrapper functions 134a-b may be implemented across any of components within the system 100. However, this information is illustrated within the data repository 128 for purposes of clarity and explanation.

In one or more embodiments, an instrumented system call wrapper function (such as any of instrumented system call wrapper functions 134a-b) includes: (a) a system call wrapper function corresponding to the instrumented system call wrapper function (and/or a call to a system call wrapper function corresponding to the instrumented system call wrapper function) and (b) instrumentation code. As illustrated, for example, instrumented system call wrapper function 134a corresponds to system call wrapper function 132a. Instrumented system call wrapper function 134a includes (a) system call wrapper function 132a and (b) instrumentation code 130a. Similarly, instrumented system call wrapper function 134b corresponds to system call wrapper function 132b. Instrumented system call wrapper function 134b includes (a) system call wrapper function 132b and (b) instrumentation code 130b.

An instrumented system call wrapper function includes a system call wrapper function corresponding to the instrumented system call wrapper function. The instrumented system call wrapper function includes a copy of the code of the original system call wrapper function. Additionally or alternatively, an instrumented system call wrapper function includes a call to a system call wrapper function corresponding to the instrumented system call wrapper function. The instrumented system call wrapper function calls the original system call wrapper function, rather than the instrumented system call wrapper function itself (such that there is no endless loop calling the instrumented system call wrapper function).

An instrumented system call wrapper function includes instrumentation code. As described above with reference to FIG. 1A, instrumentation code (such as any of instrumentation code 130a-b) is configured to perform one or more of: (a) capturing data associated with executing the set of operations associated with requesting the system call, and (b) manipulating and/or controlling execution of the set of operations associated with requesting the system call.

Capturing data associated with executing the set of operations associated with requesting the system call may include capturing, for example, parameters being input to the particular system call wrapper function, an output of the particular system call wrapper function, exception data generated by the particular system call wrapper function, and/or any other data being processed by the particular system call wrapper function. Such information may provide a context and/or a state associated with an application executing within an instrumented software package instance. Additionally or alternatively, capturing data associated with executing the set of operations associated with requesting the system call may include capturing attributes and/or statistics associated with executing the set of operations associated with requesting the system call. Such attributes and/or statistics include, for example, a number of times that the instrumented system call wrapper function is executed, a timestamp associated with execution of the instrumented system call wrapper function, and/or an identifier of a processes within the set of code, of the instrumented software package, that calls the instrumented system call wrapper function.

Manipulating and/or controlling execution of the set of operations associated with requesting the system call may include, for example, permitting or blocking execution of the associated system call wrapper function, modifying operations within the associated system call wrapper function, skipping particular operations within the associated system call wrapper function, adding particular operations to the associated system call wrapper function, branching and/or jumping to other instructions while executing the associated system call wrapper function, adding pre-processing and/or post-processing code to the associated system call wrapper function, modifying data being input to the associated system call wrapper function, and/or modifying data being output from the associated system call wrapper function. Manipulating execution of the set of operations associated with requesting the system call may include, for example, invoking an external function (such as, adding a callback and/or a webhook). The manipulation of the execution of the set of operations associated with requesting the system call may be conditioned upon certain criteria.

As an example, a system call wrapper function may include:

(a) storing Parameter A into Register A;
(b) storing Parameter B into Register B;
(c) invoking a system call to read a number of bytes indicated by Register B, from the address indicated by Register A; and
(d) returning the data that was read.

A first portion of instrumentation code may be inserted prior to the code for storing Parameter A into Register A. The first portion of instrumentation code may capture the value Parameter A.

A second portion of instrumentation code may be inserted prior to the code for invoking a system call to read a number of bytes indicated by Register B, from the address indicated by Register A. The second portion of instrumentation code may check whether the address indicated by Register A is a valid address. If the address is valid, the second portion of instrumentation code allows the operation to proceed. The system call to read from the address indicated by Register A is performed. If the address is not valid, the second portion of instrumentation code blocks the operation from proceeding. The system call to read from the address indicated by Register A is not performed. An error message may be generated.

A third portion of instrumentation code may be inserted prior to the code for returning the data that was read. The third portion of instrumentation code may modify the code for returning the data that was read. In particular, the third portion of instrumentation code may invoke an external set of code that performs a security check on the data that was read. The external set of code checks whether the data that was read include confidential information. If the external set of code returns false (the data that was read does not include confidential information), then the third portion of instrumentation code allows the data that was read to be returned. If the external set of code returns true (the data that was read includes confidential information), then the third portion of instrumentation code includes code that returns dummy data, rather than the data that was read. Dummy data may be a random set of characteristics, digits, and/or bytes.

In one or more embodiments, one or more instrumented system call wrapper functions 134a-b are collectively stored together in an instrumented library. One or more instrumented libraries may be stored in an instrumentation data repository 128. A particular instrumented system call wrapper function may be stored in multiple instrumented libraries within an instrumentation data repository 128.

Each instrumented library of instrumented system call wrapper functions corresponds to a respective library of system call wrapper functions. An instrumented library includes an instrumented system call wrapper function for each system call wrapper function included in the corresponding library. As an example, an instrumented version of the library glibc includes an instrumented system call wrapper function for each system call wrapper function within glibc. An instrumented version of the library libc includes an instrumented system call wrapper function for each system call wrapper function within libc.

In one or more embodiments, an instrumented software package 104 is a software package that includes instrumentation code.

In one or more embodiments, applications 125 of an instrumented software package 104 may be the same as applications 124 of a software package 102 from which the instrumented software package 104 was generated. Applications 124 of a software package 102 may be but are not necessarily modified when inserting instrumentation code into the software package 102 to generate an instrumented software package 104.

In one or more embodiments, an instrumented library 124 of an instrumented software package 104 includes one or more instrumented system call wrapper functions 134a-b. The instrumented system call wrapper functions 134a-b correspond to respective system call wrapper functions 132a-b of a software package 102 from which the instrumented software package 104 was generated. As described above, an instrumented system call wrapper function (such as any of instrumented system call wrapper functions 134a-b) includes: (a) a system call wrapper function corresponding to the instrumented system call wrapper function and (b) instrumentation code.

In one or more embodiments, configurations 127 of an instrumented software package 104 may be the same as configurations 126 of a software package 102 from which the instrumented software package 104 was generated. Additionally or alternatively, configurations 127 of an instrumented software package 104 may be different than configurations 126 of a software package 102 from which the instrumented software package 104 was generated. In particular, configurations 127 of an instrumented software package 104 may include one or more instrumentation configurations.

As described above with reference to FIG. 1A, an instrumentation configuration 126 sets states for various portions of the instrumentation code within an instrumented software package.

As an example, an instrumented software package may include the following instrumentation code:

(a) a first portion of instrumentation code that captures data input into Method A; and
(b) a second portion of instrumentation code that blocks execution of Method B if data being input to Method B satisfies a certain criteria.

An instrumentation configuration for the instrumented software package may indicate that the first portion of instrumentation code is set to an on state. The instrumentation configuration may further indicate that the second portion of instrumentation code is set to an off state.

Based on the above example, when an instance of the instrumented software package is executed, the first portion of instrumentation code is executed to capture data input into Method A. However, the second portion of instrumentation code is not executed. Execution of Method B is not blocked, even if data being input to Method B satisfies the criteria.

FIG. 1C illustrates example instrumented software package instances, in accordance with one or more embodiments. As illustrated in FIG. 1C, a host machine 140 includes one or more instrumented software package instances 106a-b, a software package platform 142, and an OS 144. The OS 144 is associated with one or more system calls 146 and a kernel 148. In one or more embodiments, a host machine 140 may include more or fewer components than the components illustrated in FIG. 1C. The components illustrated in FIG. 1C may be local to or remote from each other. The components illustrated in FIG. 1C may be implemented in software and/or hardware. Each component may be distributed over multiple applications and/or machines. Multiple components may be combined into one application and/or machine. Operations described with respect to one component may instead be performed by another component. Components labeled with the same numerals refer to the same components across FIGS. 1A-C.

In one or more embodiments, a host machine 140 is any machine that is configured to execute a set of code. A host machine 140 may be a physical machine and/or a virtual machine. A host machine 140 for instrumented software package instances 106a-b may itself be a guest of another host machine. As an example, a digital device may execute a VM instance. The VM instance may execute a container instance. In this example, the VM instance is a host machine for the container instance. However, the VM instance is a guest of the digital device. The digital device is a host machine of the VM instance.

In one or more embodiments, a host machine 140 is configured to operate in one of a set of operating modes. Each operating mode is associated with different restrictions on the type and scope of operations that may be performed.

An operating mode is associated with a kernel 138 of an OS 144. The operating mode may be referred to as an “unrestricted mode” or “kernel mode.” In kernel mode, a host machine 140 is allowed to perform any operation allowed by the architecture of the host machine 140. For example, any instruction may be executed, any I/O operation may be initiated, and any area of memory may be accessed.

One or more operating modes are associated with applications, middleware programs, and non-supervisory portions of the OS 144. Such an operating mode may be referred as a “restricted mode” or “user mode.” In user mode, certain instructions are not permitted. For example, certain I/O operations are not permitted, and some memory areas cannot be accessed. Operations allowed in user mode may be a subset of operations allowed in kernel mode. Additionally or alternatively, operations allowed in user mode are different than operations allowed in kernel mode. If a particular application needs to directly perform any operations that are restricted to the kernel mode, then the particular application must be granted special kernel privileges.

In one or more embodiments, an OS 144 is system software that manages hardware and software resources of a host machine 140. The OS 144 provides common services for computer programs on the host machine 140. The OS 144 provides a software platform on top of which middleware programs and/or applications can run. Examples of OS include Linux, DOS, Windows, and macOS.

In one or more embodiments, a kernel 138 is a core of an OS 144. A kernel's 138 primary function is to mediate access to resources of a host machine 140. Such resources include, for example, a central processing unit (CPU), random-access memory (RAM), and input/output (I/O) devices.

In an embodiment, a kernel 138 is one of the first programs loaded when booting a host machine 140. The following is an example of a boot process. Additional and/or alternative steps may be included in a boot process.

First, there is the loading and execution of a BIOS (Basic Input/Output System). A host machine 140 loads the BIOS, or another non-volatile firmware that starts the boot process, into memory. The host machine 140 executes the BIOS. The BIOS identifies hardware components of the host machine 140 and checks the basic operability of the hardware components. The BIOS searches attached disks for a boot record. In some embodiments, an EFI (Extensible Firmware Interface) is used in lieu of or in addition to a BIOS.

Second, there is the loading and execution of the boot record. The host machine 140 loads the boot record into memory. The host machine 140 executes the boot record. The boot record locates a kernel 138.

Third, there is the loading and execution of the kernel 138. The host machine 140 loads the kernel 138 into memory. The host machine 140 may load the kernel 138 in one stage or in multiple stages. The kernel 138, if compressed, decompresses itself. The kernel 138 sets up system functions such as essential hardware and memory paging. The kernel 138 starts up a master system service. The master system service is configured to load other system services. In a Linux system, for example, the master system service may be referred to as systemd or init. The kernel 138 handles the loading, initialization, and/or execution of the master system service and/or other system services.

In an embodiment, a kernel 138 is given unlimited access to operations and/or memory areas. As described above, a kernel 138 is executed in kernel mode. Additionally or alternatively, a kernel 138 is loaded in a separate area of memory, within a host machine 140, which is protected from access by middleware programs, applications, and other less critical parts of the OS 144.

In one or more embodiments, a system call 146 is a request, from a program, for a service from a kernel 138 of an OS 144 on which the program executes. In an embodiment, certain operations are permitted only in kernel mode. A program executing in restricted mode must use a system call to request a kernel 138 to perform such operations on its behalf. In response to the system call, the kernel 138 performs the requested operations in kernel mode. Requiring the use of a system call to perform certain operations protects the host machine 140, and/or other programs executing on the host machine 140, from being altered or damaged by a particular program.

As described above, a software package 102 includes one or more system call wrapper functions 132a-132b, and an instrumented software package 104 includes one or more instrumented system call wrapper functions 134a-b. The call to a system call wrapper function (or an instrumented system call wrapper function) itself does not cause a switch from user mode to kernel mode. Meanwhile, the actual system call transfers control to the kernel 138, resulting in a switch from user mode to kernel mode.

In one or more embodiments, a software package platform 142 is a platform on which one or more instrumented software package instances 106a-b may be executed. In hardware virtualization, for example, a hypervisor executes one or more VM instances. The VM instances share one or more virtualized hardware resources. As an example, a Linux VM instance and a Windows VM instance may both execute on a single physical x86 machine. Meanwhile, the Linux VM instance and the Windows VM may each be associated with its own kernel. In operating system level virtualization, a container platform allows one or more container instances to execute on a single kernel. Examples of container platforms include Docker, CoreOS Rocket (or RedHat Rocket), and/or Canonical LXD.

4. Generating an Instrumented Software Package

FIGS. 2A-B illustrate an example set of operations for generating an instrumented software package, in accordance with one or more embodiments. One or more operations illustrated in FIG. 2 may be modified, rearranged, or omitted all together. Accordingly, the particular sequence of operations illustrated in FIG. 2 should not be construed as limiting the scope of one or more embodiments.

One or more embodiments include obtaining a software package including a set of code to be executed on an operating system (OS) (Operation 202). An analysis engine (and/or an instrumentation module thereof) obtains a software package from a user and/or another application. In an embodiment, a software developer may push a software package onto a deployment pipeline in a continuous delivery and/or continuous deployment system. An analysis engine sits on the deployment pipeline. The analysis engine obtains the software package from a prior entity on the deployment pipeline.

One or more embodiments include identifying, within the software package, one or more wrapper functions for one or more system calls to a kernel of the OS (Operation 204). The analysis engine traverses the files and/or code of the software package, to identify one or more system call wrapper functions within the software package. As an example, an analysis engine traverses a software package to identify a glibc, which is a library defining system call wrapper functions.

One or more embodiments include determining whether there is a corresponding instrumented wrapper function for each wrapper function in the software package (Operation 206). An instrumentation data repository stores instrumented system call wrapper functions and/or instrumented libraries of instrumented system call wrapper functions. The analysis engine searches through the instrumentation data repository for an instrumented system call wrapper function corresponding to each of the system call wrapper functions identified at Operation 204. An instrumented system call wrapper function corresponding to a particular system call wrapper function includes (a) the particular system call wrapper function and (b) instrumentation code.

If there is a corresponding instrumented wrapper function, then one or more embodiments include adding the instrumented wrapper function into the software package (Operation 208). The analysis engine obtains, from the instrumentation data repository, each instrumented system call wrapper function that corresponds to a system call wrapper function in the software package. The analysis engine adds the instrumented system call wrapper functions in the software package. The analysis engine may but does not necessarily remove the system call wrapper functions from the software package.

If there is a corresponding instrumented wrapper function, then one or more embodiments include keeping the wrapper function in the software package (Operation 210). The system call wrapper function originally identified in the software package remains in the software package.

In one or more embodiments, system call wrapper functions are stored collectively in a library, such as glibc. The analysis engine traverses through the files within the software package to identify a library of system call wrapper functions. The analysis engine searches through the instrumentation data repository for an instrumented library corresponding to the library of system call wrapper functions identified. The analysis engine adds the instrumented library into the software package. If a corresponding instrumented library is not found for a particular library within the software package, then the particular library remains in the software package.

One or more embodiments include generating an instrumented software package including the set of code and one or more instrumented wrapper functions (Operation 212). The analysis engine generates an instrumented software package. The instrumented software package includes code from the software package, such as code for one or more applications, and/or code for one or more libraries. Moreover, the instrumented software package includes instrumented system call wrapper functions. The instrumented system call wrapper functions may be stored collectively in an instrumented library.

One or more embodiments include executing an instance of the instrumented software package on a host machine (Operation 214). A host machine instantiates the instrumented software package to generate an instrumented software package instance. The host machine executes the instrumented software package instance on a software package platform. In an embodiment, the instrumented software package instance is executed in “observation mode.” In observation mode, the code of the instrumented software package instance may be executed for purposes of testing, however applications are not made available for use by the public and/or the customers.

During execution of the instrumented software package instance, application code is executed. The application code makes calls to one or more system call wrapper functions. In response to a call, from the application code, to a particular system call wrapper function, the host machine identifies an instrumented system call wrapper function corresponding to the particular system call wrapper function. The instrumented system call wrapper function is executed. During execution of the instrumented software package instance, a call to a system call wrapper function results in execution of an instrumented system call wrapper function, rather than the corresponding system call wrapper function.

As an example, an instrumented software package may include both (a) an instrumented system call wrapper function and (b) a corresponding system call wrapper function. During instantiation and/or initialization of the instrumented software package, a loading sequence for associated files may be defined. The loading sequence may specify that an instrumented library including an instrumented system call wrapper function is loaded before a library including a corresponding system call wrapper function is loaded. When a call is made to a system call wrapper function, the host machine searches through the associated files in the order in which the files were loaded. Since the instrumented library was loaded before the library was loaded, the instrumented library is searched first. The instrumented system call wrapper function is found within the instrumented library and is thereby executed. The corresponding system call wrapper function is not executed.

As another example, an instrumented software package may include both (a) an instrumented system call wrapper function and (b) a corresponding system call wrapper function. During instantiation and/or initialization of the instrumented software package, the instrumented software package may be configured to execute the instrumented system call wrapper function, rather than the corresponding system call wrapper function.

As another example, an instrumented software package may include a particular instrumented system call wrapper function without including the corresponding system call wrapper function. Hence, a call to a system call wrapper function is a call to the instrumented system call wrapper function. The instrumented system call wrapper function is executed. Within the instrumented software package, there is no corresponding system call wrapper function that can be executed.

In an embodiment, execution of an instrumented system call wrapper function, including the instrumentation code thereof, does not require any special kernel privileges. The instrumented system call wrapper function is executed in response to a call from application code.

In an embodiment, the call from application code to an instrumented system call wrapper function is executed in user mode. The call to the instrumented system call wrapper function does not result in a switch to kernel mode. Code within the instrumented system call wrapper function that makes an actual system call may cause a switch to kernel mode.

One or more embodiments include obtaining data, captured via the instrumentation code, associated with executing the instrumented wrapper functions (Operation 216). As the instrumented software package instance is executed, one or more instrumented system call wrapper functions are executed. Execution of an instrumented system call wrapper function includes: execution of the particular system call wrapper function and execution of instrumentation code. At least a portion of instrumentation code is configured to capture data associated with executing the particular system call wrapper function. Hence, the instrumentation code captures data associated with executing the particular system call wrapper function.

The analysis engine obtains the captured data and stores the captured data into a captured data repository. The captured data is stored in the captured data repository for analysis. The captured data may be analyzed to determine, for example, a performance level of the instrumented software package instance, whether and/or how the instrumented software package instance is being attacked, and/or a behavior of the instrumented software package instance. As an example, an application external to the instrumented software package may access the captured data repository to analyze the captured data. As another example, a user interface may present information associated with the captured data stored in the captured data repository.

One or more embodiments include determining an instrumentation configuration for the instrumented software package instance based on the captured data (Operation 218).

Based on the captured data from Operation 216, the analysis engine determines a behavior of the instrumented software package instance.

As an example, data captured, via instrumentation code within an instrumented system call wrapper function, may indicate that parameters to a particular method include identifiers used in a particular database. By analyzing the data that is captured, an analysis engine may determine that the behavior of the instrumented software package instance includes interacting with the particular database.

As another example, data captured, via instrumentation code within an instrumented system call wrapper function, may indicate that data being processed by a particular method is encrypted. By analyzing the data that is captured, an analysis engine may determine that the behavior of the instrumented software package instance includes performing data encryption.

In an embodiment, a data repository stores a set of behavior templates. Each of the set of behavior templates is associated with certain characteristics of captured data. The association between behavior templates and captured data may be specified via user input, and/or specified by another application. Additionally or alternatively, the association between behavior templates and captured data may be learned via machine learning.

The analysis engine compares the captured data, from execution of the instrumented software package instance, with the characteristics of captured data associated with the set of behavior templates. If there is a match between (a) the captured data, from execution of the instrumented software package instance, and (b) the characteristics of captured data associated with a particular behavior template, from the set of behavior templates, then the analysis engine determines that the particular behavior template is associated with the instrumented software package instance.

As an example, a data repository may include the following behavior templates:

(a) a database behavior template, which is associated with captured data that includes identifiers used in the particular database; and
(b) an encryption behavior template, which is associated with captured data that includes encrypted data.

An instrumented software package instance may be executed. During execution, data may be captured via instrumentation code. The captured data may include identifiers used in the particular database. An analysis engine may determine that the captured data matches with the characteristics of captured data associated with the database behavior template. Hence, the analysis engine may determine that the database behavior template is associated with the instrumented software package instance.

Based on the behavior of the instrumented software package instance, the analysis engine determines an instrumentation configuration for the instrumented software package instance. The analysis engine may determine the instrumentation configuration based on the behavior of the instrumented software package instance using a set of rules. Additionally or alternatively, the analysis engine may determine the instrumentation configuration based on the behavior of the instrumented software package instance based on a mapping between instrumentation configurations and instrumented software package instance behaviors. The rules and/or mapping may be specified via user input, and/or specified by another application. Additionally or alternatively, the rules and/or mapping may be learned via machine learning.

As an example, a behavior of an instrumented software package instance may be determined to include interacting with a particular database. A rule may state that for database-related behavior, portions of instrumentation code that capture data associated with Method XYZ must be turned on. Based on the rule, an analysis engine may turn on any portion of instrumentation code that captures data associated with Method XYZ.

As another example, an instrumented library within an instrumented software package may include: Instrumented Wrapper Function A, and Instrumented Wrapper Function B. Possible instrumentation configurations for the instrumented library may include, for example:

(a) a first instrumentation configuration indicating: (i) a first portion of instrumentation code configured to capture data, in Instrumented Wrapper Function A, are turned on, and (ii) a second portion of instrumentation code configured to capture data, in Instrumented Wrapper Function B, are turned off; and
(b) a second instrumentation configuration indicating: (i) a third portion of instrumentation code configured to manipulate execution of operations, in Instrumented Wrapper Function B, are turned on, and (ii) a fourth portion of instrumentation code configured to manipulate execution of operations, in Instrumented Wrapper Function A, are turned off.

A data repository may store a mapping between the possible instrumentation configurations and behavior templates for the instrumented software package instance. The mapping may include, for example:

(a) a database behavior template is mapped to the first instrumentation configuration; and
(b) an encryption behavior template is mapped to the second instrumentation configuration.

An instrumented software package instance may be executed. Based on captured data, an encryption behavior template may be determined as being associated with the instrumented software package instance. Based on the mapping, an analysis engine may apply the second instrumentation configuration to the instrumented software package instance. The analysis engine may turn on the third portion of instrumentation code configured to manipulate execution of operations in Instrumented Wrapper Function B. The analysis engine may turn off the fourth portion of instrumentation code configured to manipulate execution of operations in Instrumented Wrapper Function A.

One or more embodiments include configuring the instrumented software package instance based on the instrumentation configuration (Operation 220). The analysis engine configures the instrumented software package instance based on the instrumentation configuration determined at Operation 218. The analysis engine may configure the instrumented software package instance by including a configuration file within the instrumented software package that includes the instrumentation configuration. Additionally or alternatively, the analysis engine may configure a software package platform, which executes the instrumented software package instance, to apply the instrumentation configuration to the instrumented software package instance.

In an embodiment, Operations 214-220 may be iterated multiple times in order to determine an instrumentation configuration that is most appropriate for the instrumented software package instance. As an example, on a first iteration, a first set of data is captured from an instrumented software package instance. Based on the first set of captured data, a first instrumentation configuration is determined and applied to the instrumented software package instance. On a second iteration, a second set of data is captured from the instrumented software package instance, while configured using the first instrumentation configuration. Based on the second set of captured data, a second instrumentation configuration is determined and applied to the instrumented software package instance.

One or more embodiments include executing an instance of the instrumented software package, configured with the instrumentation configuration (Operation 222). The instrumented software package instance is configured with the instrumentation configuration based on (a) a configuration file within the instrumented software package and/or (b) a configuration of a software package platform that executes the instrumented software package instance. A host machine instantiates the instrumented software package, which includes the configuration file with the instrumentation configuration. Additionally or alternatively, the host machine instantiates the instrumented software package using the software package platform that has been configured to apply the instrumentation configuration to the instrumented software package instance. Hence, the host machine executes the instrumented software package instance, configured with the instrumentation configuration.

5. Randomizing an Instrumentation Configuration for Instrumented Software Package Instances

FIG. 3 illustrates an example set of operations for randomizing an instrumentation configuration for instrumented software package instances, in accordance with one or more embodiments. One or more operations illustrated in FIG. 3 may be modified, rearranged, or omitted all together. Accordingly, the particular sequence of operations illustrated in FIG. 3 should not be construed as limiting the scope of one or more embodiments.

One or more embodiments include identifying multiple instances of one or more instrumented software packages executing on one or more host machines (Operation 302). An analysis engine (and/or a randomization module thereof) identifies instances of one or more instrumented software packages executing on one or more host machines. Instances of different instrumented software packages may be executed. Additionally or alternatively, multiple instances of the same instrumented software package may be executed. Moreover, the instrumented software package instances may be executed on the same host machine and/or different host machines.

One or more embodiments include executing a random function to determine any modifications to an instrumentation configuration of any instrumented software package instance (Operation 304). The analysis engine executes a random function to determine any modifications to an instrumentation configuration of any instrumented software package instance.

In an embodiment, the analysis engine selects a first instrumented software package instance from a set of instrumented software package instances. The analysis engine determines an instrumented software package corresponding to the first instrumented software package instance. The analysis engine scans through the instrumented software package to identify portions of instrumentation code that have previously been set to an on state. The analysis engine performs an execution of a random function for each portion of instrumentation code that is in an on state. Each output from the random function indicates whether a respective portion of instrumentation code should remain in an on state, or be modified to being in an off state. The analysis engine turns on or off each portion of instrumentation code accordingly. The analysis engine then iterates the above steps with respect to a second instrumented software package instance from the set of instrumented software package instances. The analysis engine iterates the above steps until all of the set of instrumented software package instances are processed.

In an embodiment, a random function may output at least four possible results: (a) apply the instrumentation configuration as determined based on the behavior of the instrumented software package instance (as determined at Operation 218), (b) use the instrumentation configuration determined based on the behavior of the instrumented software package instance, except set all portions of instrumentation code that capture data to an off state, (c) use the instrumentation configuration determined based on the behavior of the instrumented software package instance, except set all portions of instrumentation code that manipulate execution of an instrumented system call wrapper function to an off state, or (d) set all instrumentation code to an off state. The analysis engine may apply the random function to each of a set of instrumented software package instances.

In an embodiment, a set of instrumented system call wrapper functions may be divided into groups. The grouping may be determined based on, for example, a functionality of the system call wrapper functions. As an example, a first group may include network-related system call wrapper functions; a second group may include storage-related system call wrapper functions. Hence, a particular instrumented software package may include multiple groups of instrumented system call wrapper functions. The analysis engine may perform an execution of a random function for each group within a particular instrumented software package. An output from a first execution of the random function determines modifications to instrumentation configurations of the first group of instrumented system call wrapper functions. An output from a second execution of the random function determines modifications to instrumentation configurations of the second group of instrumented system call wrapper functions.

In an embodiment, a set of instrumented software package instances may be divided into groups. The grouping may be determined based on, for example, a functionality of the instrumented software package instances and/or a geographical location associated with the instrumented software package instances. The analysis engine may perform an execution of a random function for each group. An output from a first execution of the random function determines modifications to instrumentation configurations of the first group of instrumented software package instances. An output from a second execution of the random function determines modifications to instrumentation configurations of the second group of instrumented software package instances.

Various additional and/or alternative methods may be used for executing a random function to determine any modifications to an instrumentation configuration of any instrumented software package instance. Based on execution of the random function, instances of the same instrumented software package may behave differently. A particular portion of instrumentation code may be set to an on state for one instance, and the particular portion of instrumentation code may be set to an off state for another instance.

In some embodiments, modifications to an instrumentation configuration of an instrumented software package instance may be additionally and/or alternatively determined based on various factors. As an example, modifications to an instrumentation configuration of an instrumented software package instance may be determined based on a geographical location of a physical server and/or machine that executes the instrumented software package instance. A first modification may be applied to a first set of instrumented software package instances associated with Canada; a second modification may be applied to a second set of instrumented software package instances associated with the United States. As another example, modifications to an instrumentation configuration of an instrumented software package instance may be determined based on external data (such as, data from a user and/or other applications) being handled by the instrumented software package instance. A first modification may be applied to a first set of instrumented software package instances handling high-security data (such as, banking data); a second modification may be applied to a second set of instrumented software package instances handling low-security data.

One or more embodiments include modifying an instrumentation configuration for each instrumented software package instance based on the output of the random function (Operation 306). The analysis engine applies the modifications, determined at Operation 304, to the configurations of the instrumented software package instances. The analysis engine may modify a configuration file within and/or otherwise associated with each instrumented software package. Additionally or alternatively, the analysis engine may configure software package platforms, which execute the instrumented software package instances, to modify the instrumentation configurations.

In an embodiment, the modification to the instrumentation configuration are performed without turning off, restarting, suspending, pausing, and/or interrupting the instrumented software package instances. After the modifications are applied to the instrumentation configurations, the modifications take effect on the associated instrumented software package instances, without turning off, restarting, suspending, pausing, and/or interrupting the instrumented software package instances.

One or more embodiments include determining whether the next randomization is needed (Operation 308). The next randomization may be triggered based on a periodic schedule and/or a triggering event. As an example, randomizations may be scheduled to occur once every three hours. Three hours after the last randomization was performed, a next randomization should occur. As another example, randomizations may be triggered based on security alerts. A potential attacker on a set of instrumented software package instances may be detected. Based on the detection of the potential attacker, a next randomization should occur. The randomization changes the behaviors of the instrumented software package instances, which reduces the likelihood of a successful attack by the potential attacker.

8. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

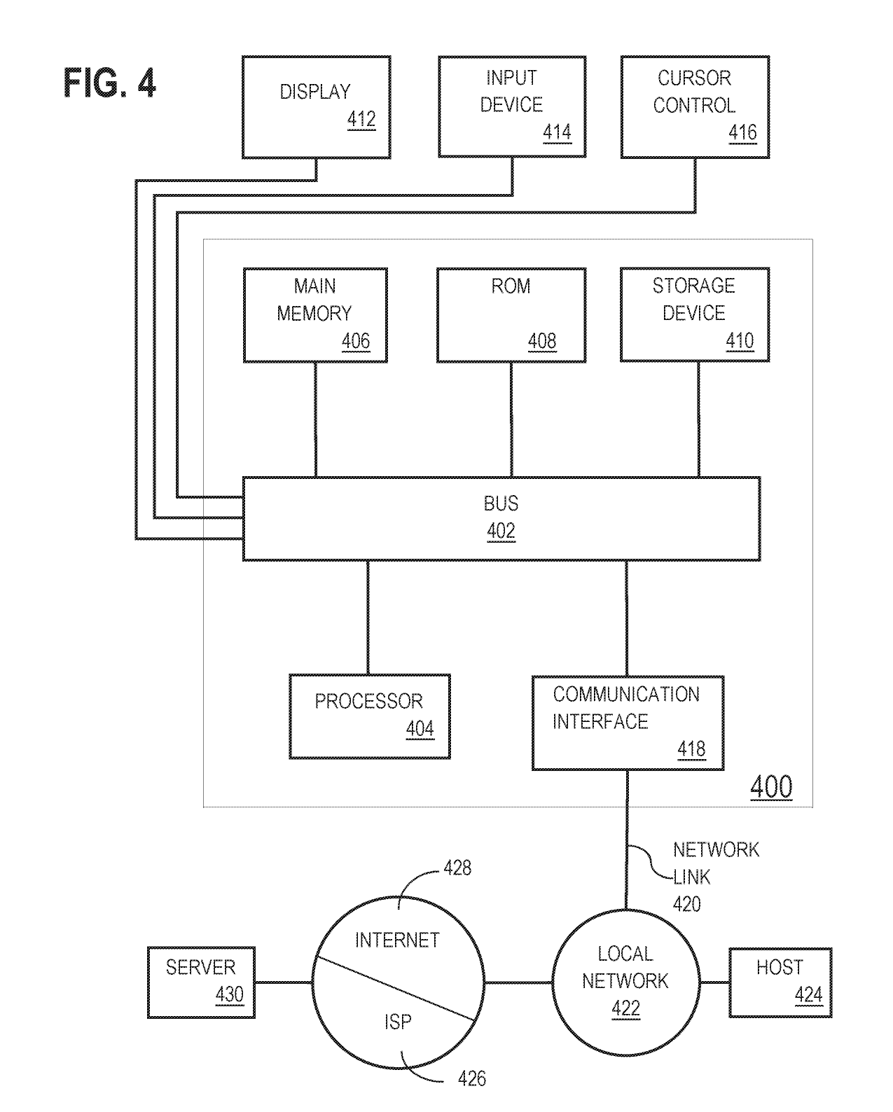

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 410. Volatile media includes dynamic memory, such as main memory 406. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

9. Miscellaneous; Extensions

Embodiments are directed to a system with one or more devices that include a hardware processor and that are configured to perform any of the operations described herein and/or recited in any of the claims below.

In an embodiment, a non-transitory computer readable storage medium comprises instructions which, when executed by one or more hardware processors, causes performance of any of the operations described herein and/or recited in any of the claims.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A non-transitory computer readable medium comprising instructions which, when executed by one or more hardware processors, cause performance of steps comprising:
obtaining a software package including a set of code to be executed on an operating system (OS);
identifying, within the software package, a wrapper function for a system call to a kernel of the OS, wherein the wrapper function includes a set of operations associated with requesting the system call;
obtaining an instrumented wrapper function for the system call to the kernel of the OS, wherein the instrumented wrapper function includes:
(a) the wrapper function; and
(b) instrumentation code configured to perform one or more of: (i) capturing data associated with executing the set of operations associated with requesting the system call, and (ii) manipulating execution of the set of operations associated with requesting the system call;
generating an instrumented software package including:
(a) the set of code; and
(b) the instrumented wrapper function;
wherein a call to the wrapper function, by the set of code, results in executing the instrumented wrapper function instead of the wrapper function.

2. The medium of claim 1, wherein the software package is a container image.

3. The medium of claim 1, wherein the software package does not include the kernel of the OS.

4. The medium of claim 1, wherein multiple instances of the software package are executable on the kernel of the OS.

5. The medium of claim 1, wherein the set of code corresponds to a plurality of applications, and each of the plurality of applications are configured to access the instrumented wrapper function.

6. The medium of claim 1, wherein the data associated with executing the set of operations associated with requesting the system call comprises one or more of: input parameters to the wrapper function, data being processed by the wrapper function, output data generated by the wrapper function, exception data generated by the wrapper function, and an identifier of a process within the set of code that calls the wrapper function.

7. The medium of claim 1, wherein the data associated with executing the set of operations associated with requesting the system call is transmitted to an analysis application for analyzing a behavior of an instance of the software package.

8. The medium of claim 1, wherein the data associated with executing the set of operations associated with requesting the system call is accessed by an application external to the software package.

9. The medium of claim 1, wherein manipulating the execution of the set of operations associated with requesting the system call is performed by one or more of: blocking at least one of the set of operations associated with requesting the system call, and modifying at least one of the set of operations associated with requesting the system call.

10. The medium of claim 1, wherein the operations further comprise:
obtaining the data associated with executing the set of operations associated with requesting the system call, wherein the data is captured by an instance of the software package by executing the instrumentation code configured to capture the data associated with executing the set of operations associated with requesting the system call.

11. The medium of claim 10, wherein the operations further comprise:
based on the data associated with executing the set of operations associated with requesting the system call: determining whether to set an on state or an off state for the instrumentation code configured to manipulate the execution, by the instance of the software package, of the set of operations associated with requesting the system call.

12. The medium of claim 1, wherein the operations further comprise:
setting an instrumentation configuration for an instance of the software package that sets an on state or an off state for the instrumentation code in the instrumented wrapper function.

13. The medium of claim 1, wherein the operations further comprise:
executing a random function to determine whether to set an on state or an off state for the instrumentation code in the instrumented wrapper function for a particular instance of the software package;
based on a result of the random function, setting an instrumentation configuration for the particular instance of the software package that sets an on state or an off state for the instrumentation code in the instrumented wrapper function.

14. The medium of claim 1, wherein the operations further comprise:
setting a first instrumentation configuration for a first instance of the software package that sets an on state for the instrumentation code in the instrumented wrapper function;
setting a second instrumentation configuration for a second instance of the software package that sets an off state for the instrumentation code in the instrumented wrapper function.

15. The medium of claim 1, wherein:
the software package includes a library comprising a plurality of wrapper functions for system calls to the kernel of the OS, the plurality of wrapper functions comprising the wrapper function; and
the instrumented software package includes an instrumented library comprising a plurality of instrumented wrapper functions for the system calls to the kernel of the OS, the plurality of instrumented wrapper functions including the instrumented wrapper function.

16. The medium of claim 15, wherein generating the instrumented software package comprises:
replacing the library comprising the plurality of wrapper functions with the instrumented library comprising the plurality of instrumented wrapper functions.

17. The medium of claim 15, wherein the operations further comprise:
causing loading of the instrumented library comprising the plurality of instrumented wrapper functions prior to any loading of the library comprising the plurality of wrapper functions.

18. The medium of claim 15, wherein the operations further comprise:
selecting a particular instrumentation configuration, from a plurality of instrumentation configurations, for application to an instance of the software package, the plurality of instrumentation configurations comprising:
a first instrumentation configuration indicating: (a) a first portion of instrumentation code configured to capture data, in a first subset of the plurality of instrumented wrapper functions, are turned on, and (b) a second portion of instrumentation code configured to capture data, in a second subset of the plurality of instrumented wrapper functions, are turned off;
a second instrumentation configuration indicating: (a) a third portion of instrumentation code configured to manipulate execution of operations, in a third subset of the plurality of instrumented wrapper functions, are turned on, and (b) a fourth portion of instrumentation code configured to manipulate execution of operations, in a fourth subset of the plurality of instrumented wrapper functions, are turned off;
applying the particular instrumentation configuration to the instance of the software package.

19. The medium of claim 1, wherein the instrumentation code is executable by the kernel of the OS without any kernel privileges.

20. A method, comprising:
obtaining a software package including a set of code to be executed on an operating system (OS);
identifying, within the software package, a wrapper function for a system call to a kernel of the OS, wherein the wrapper function includes a set of operations associated with requesting the system call;
obtaining an instrumented wrapper function for the system call to the kernel of the OS, wherein the instrumented wrapper function includes:
(a) the wrapper function; and
(b) instrumentation code configured to perform one or more of: (i) capturing data associated with executing the set of operations associated with requesting the system call, and (ii) manipulating execution of the set of operations associated with requesting the system call;
generating an instrumented software package including:
(a) the set of code; and
(b) the instrumented wrapper function;
wherein a call to the wrapper function, by the set of code, results in executing the instrumented wrapper function instead of the wrapper function;
wherein the method is executed by at least one device including a hardware processor.

21. A system, comprising:
at least one device including a hardware processor; and
the system being configured to perform operations comprising:
obtaining a software package including a set of code to be executed on an operating system (OS);
identifying, within the software package, a wrapper function for a system call to a kernel of the OS, wherein the wrapper function includes a set of operations associated with requesting the system call;
obtaining an instrumented wrapper function for the system call to the kernel of the OS, wherein the instrumented wrapper function includes:
(a) the wrapper function; and
(b) instrumentation code configured to perform one or more of: (i) capturing data associated with executing the set of operations associated with requesting the system call, and (ii) manipulating execution of the set of operations associated with requesting the system call;
generating an instrumented software package including:
(a) the set of code; and
(b) the instrumented wrapper function;
wherein a call to the wrapper function, by the set of code, results in executing the instrumented wrapper function instead of the wrapper function.
